(19) United States
(12) Patent Application Publication
(10) Pub. No.: US 2011/0285698 A1
(43) Pub. Date: Nov. 24, 2011

(54) Method and arrangement for three-dimensionally recognizable representation

(76) Inventors: Wolfgang Tzschoppe, Rothenstein (DE); Markus Klippstein, Muenchenroda (DE); Ingo Relke, Jena (DE); Thomas Brueggert, Jena (DE); Stephan Otte, Jena (DE)

(21) Appl. No.: 12/973,509

(22) Filed: Dec. 20, 2010

Related U.S. Application Data
(63) Continuation of application No. 10/573,190, filed on Jan. 11, 2007, now abandoned.

(30) Foreign Application Priority Data
Sep. 22, 2003 (DE) 103 44 323.1

(51) Int. Cl. G06T 15/00

(52) U.S. Cl. 345/419

(57) ABSTRACT

The invention relates to methods and arrangements for unaided three-dimensionally recognizable representation by a method for three-dimensionally recognizable representation, in which individual image elements (αᵢⱼ) are simultaneously made visible, the image elements (αᵢⱼ) reproducing partial information from several views (Aₖ (k=1 . . . n)) of the scene/object. Directions of propagation are predefined for the light emitted by the image elements (αᵢⱼ) with the aid of a structural plate. For this purpose, the structural plate includes a plurality of optical elements that are arranged in sequences. According to the invention, the mean geometrical distance (p′) between two adjacent sequences of light-transmitting optical elements on the structural plate meets the condition p′=p, wherein p=G*sin (0.017 degrees), G representing four times the diagonal length of the image element (αᵢⱼ) PO raster.

Right of priority and benefit of the filing date is herein claimed for the following US non-provisional patent application: App. No. 10573190, filed in the United States Patent and Trademark Office on Mar. 22, 2006 and titled “Method and arrangement for three-dimensionally recognizable representation” (the '190 Application). The 190 Application is herein incorporated by reference in its entirety.

### FIELD OF THE INVENTION

The invention relates to procedure and arrangements for spatially perceptible representations, in particular one that presents a spatially perceptible image to several viewers without requiring auxiliary means such as eyeglasses.

### BACKGROUND OF THE INVENTION

There are many know specialized approaches for this application area. Particularly spread are the lenticular systems, the barrier systems and the filter array systems. The applicant describes, among other things, the latest technology procedures and arrangements in WO 01/56265 and WO 03/024122.

However, with the aforementioned arrangements and procedures, a drawback frequently arises: that from a comfortable 3D viewing distance, the respective 3D optic effect is dissolvable for a normally sighted human eye, for example in the filter array, and thus a certain undesired image effect takes place. Furthermore, the perceptible resolution is reduced and/or affected by the 3D optics.

The purpose of the invention is to arrange the structure of the 3D optics for the naked eye as sharply as possible, and to improve the quality of the spatially perceptible representation.

In this regard it is well-known that for the normally sighted human eye with a visual acuity of S=1, two neighboring points under a viewing angle of approximately less than one arc minute (equivalent to approximately 0.017° in decimally divided degrees) are no longer resolvable.

### DESCRIPTION OF THE INVENTION

The purpose of the invention is to solve this issues when a spatially perceptible representation of an image is being displayed, for which a group of individual picture elements αᵢⱼ in a matrix with j lines and i columns are made visible at the same time, so that
the picture elements αᵢⱼ show partial information from several views Aₖ (k=1 . . . n) of the scene/subject,
a structural plate makes possible to force the propagation direction of the light emitted from the αᵢⱼ picture elements, and for this purpose the plate will have multiple optical elements arranged in series,
the propagation directions within the viewing area in which the viewers are, cross with the multiple intersections which correspond in each case to a viewing position,
from each viewing position, a viewer visually perceives with one eye the partial information of a first selection and with the other eye he optically perceives the partial information of a second selection from the Aₖ views (k=1 . . . n), where the invention complies with the requirement that the corresponding average geometrical distance p′ between two adjacent light-transmitting optical elements on the structural plate fulfills the p′≦p condition, on which p=G*sin (0.017°), where G is the quadruple of the diagonal length of the αᵢⱼ picture elements matrix.

When the aforementioned inequality is fulfilled, it causes that a normally sighted viewer with a visual acuity of S=1, who is watching the picture elements on the matrix from a viewing distance of the quadruple of the diagonal length of the matrix, cannot visually resolve two adjacent light-transmitting optical elements. With this, an improved spatially perceptible representation is achieved. To that effect, the mentioned inequality can only get worse, when the average geometrical distance p′ which corresponds to two adjacent successive light-transmitting optical elements on the structural plate fulfill the p′≦p′″≦p condition, on which p′″=H*sin(0.017°), where H is two-and-one-half times the diagonal length of the picture elements matrix α_{ij′}. Thereby a normally sighted viewer with a visual acuity of S=1 would not visually dissolve any more the adjacent light-transmitting optical elements from a viewing distance of two-and-one-half times the diagonal length of the matrix.

It is also possible to shape an even smaller average geometrical distance p′, so that likewise those viewers with a visual acuity of S>1 do not visually resolve the adjacent successive light-transmitting optical elements from the mentioned viewing distance.

It is advantageous to include in a structural plate several cylindrical lenses as light-transmitting optical elements arranged in p columns and q lines. In further arrangements, polarization filters, holographic-optical elements or spherical and aspheric lenses can be used as optical elements.

However, it is preferable that the structural plate includes several transparent filtering elements as light-transmitting optical elements, arranged in p columns and q lines. The transparent filtering elements are respectively located on the structural plate at least partially between basically opaque filtering elements.

For this arrangement, the transparent filter elements—essentially the entire visible spectrum—are arranged in a rectangular shape, preferably staggered between each other, whereby preferably each two partially overlap themselves respectively in adjacent lines or columns.

Such a structural plate can easily be made from exposed photographic film, which incorporates the transparent and the opaque filter elements and which is laminated on a glass plate. Further arrangements are conceivable.

Likewise filter elements can be used which are respectively transparent for light of selected wavelengths or wave ranges.

The partial information of the first and the second selections from the Aₖ views (k=1 . . . n), which a viewer optically perceives with one eye and with the other, correspond in each case to the exact partial information of one or several Aₖ views (k=1 . . . n), whereby, for example, the viewer predominantly perceives each eye the corresponding mentioned partial information for the first and second selections. This last mentioned issues are described by the applicant in more detail in DE 100 03 326 C2. In addition, it can also be favorable, if the viewer sees accurately with each eye the mentioned partial information for the first and second selections, and if these selections cover in each case a precise Aₖ view (k=1 . . . n). The applicant refers to PCT/EP2004/004464 in this regard.

A further advantageous configuration of the invention's procedures provides that the viewing area, within which the viewers may be experiencing a spatial impression, must include at least those levels which:
are in a forwards viewing direction,
are parallel to the αᵢⱼ image elements matrix, and
are located within a distance of 2.5 to 4 times the diagonal length of the matrix.

The known procedures for spatially perceptible representations, which are based on lenticular or filter arrays, usually result in a preferential viewing distance for the viewer, from which the displayed 3D image is particularly well perceptible. These preferential distances can correspond, for example, to the aforementioned 2.5 times or 4 times the diagonal length of the matrix.

This way, the preferred viewing distance which becomes inseparably related to the corresponding (minimal) required distance for not resolving visually the optical elements of the 3D optical effect (in this case, the optical elements on the structural plate).

Furthermore, the combined partial information can be favorably displayed from at least one image element αᵢⱼ with partial information of at least two different Aₖ views (k=1 . . . n) of the scene/subject. The applicant describes this approach in broader detail in WO 03/024122, which allows adjusting the structure of the displayed image from the picture elements αᵢⱼ to the respective geometrical conditions of the used structural plate, in particular for a filter array.

The purpose of the invention is to solve the issue of an arrangement for the spatially perceptible representation of a scene/subject, including:
an image rendering device with multiple individual picture elements αᵢⱼ in a matrix with j lines and i columns, on which the αᵢⱼ picture elements are the displayable partial information from several Aₖ views (k=1 . . . n) of the scene/subject.
at least one structural plate in the viewing direction in front or behind the image reproduction mechanism, arranged to direct the required propagation direction of the light radiated from the αᵢⱼ picture elements, where the structural plate shows multiple optical elements arranged accordingly for this purpose,
that the propagation directions within the viewing area in which the viewers are, cross with the multiple intersections which correspond to individual viewing positions, so that from each viewing position a viewer optically perceives with one eye the partial information of a first selection and with the other eye the partial information of a second selection from the Aₖ views (k=1 . . . n), whereby according to the invention:
the average geometrical distance p′ for each of the two adjacent successive light-transmitting optical elements on the structural plate fulfill the p′≦p condition, on which p=G*sin (0.017°), where G is the quadruple of the diagonal length of the picture elements matrix αᵢⱼ.

The image rendering device with multiple individual picture elements α₀ in a matrix with j lines and i columns i can be, for example, a 17″ TFT-LCD monitor like the ViewSonic VX700 or the 50″ Pioneer PDP 503 MXE plasma monitor, on which the picture elements αᵢⱼ correspond to the RGB color sub pixels. An electronic control system, which can consist, for example, of a commercial PC, ensures that the αᵢⱼ picture elements display the partial information from the different Aₖ views (k=1 . . . n) of the scene/subject.

It is preferable to use a structural plate with several cylindrical lenses arranged in p columns and q lines as light-transmitting optical elements.

However, the structural plate will preferably include several transparent filter elements arranged in p columns and q lines as light-transmitting optical elements. Thereby, the transparent filter elements are respectively located on the structural plate at least partially between essentially opaque filter elements.

In this preferred arrangement, the transparent filter elements for the entire visible light are arranged in a rectangular array, preferably staggered between each other, where every two transparent filters partially overlap themselves respectively in adjacent lines and columns. Other forms than rectangular shapes are also feasible for the transparent filters.

Such a structural plate can easily be made from exposed photographic film, which incorporates the transparent and the opaque filter elements and which is laminated on a glass plate. Further arrangements are imaginable.

In a special arrangement of the configuration according to the invention, the average geometrical distance p′ fulfills the p′≦p′″≦p condition, for two contiguous successive light-transmitting optical elements on the structural plate, on which p′″=H*sin (0.017°) applies, where H is two-and-one-half times the diagonal length of the picture elements matrix α_{ij′}. Thereby the normally sighted viewer with a visual acuity of S=1 would not visually resolve any more the adjacent light-transmitting optical elements already from a viewing distance of the two-and-one-half times one of the diagonal length of the matrix.

The partial information of first and the second selections from the Aₖ views (k=1 . . . n), which a viewer visually perceives respectively with each eye, correspond in each case to the precise partial information from one or more the Aₖ views (k=1 . . . n), whereby the viewer can perceive with each eye the preponderant or exclusive mentioned partial information from the first and second selections.

A further advantageous configuration of the invention's configuration procedures considers that the viewing area in which the viewers are, must include at least those levels that:
are in a forwards viewing direction,
are parallel to the αᵢⱼ image elements matrix, and
are located within a distance of 2.5 or 4 times the diagonal length of the matrix.

The known arrangements for spatially perceptible representations, which are based on lenticular or filter arrays, usually result in a preferential viewing distance for the viewer, from which the displayed 3D image is particularly well perceptible. These preferential distances can correspond, for example, to the aforementioned 2.5 times or 4 times the diagonal length of the matrix.

This way, the preferred viewing distance which becomes inseparably related to the corresponding (minimal) required distance for not resolving visually the optical elements of the 3D optical effect (in this case, the optical elements on the structural plate).

Furthermore, at least one αᵢⱼ image element can displayed the combined partial information from the partial information of at least two different Aₖ views (k=1 . . . n) of the scene/subject.

### BRIEF DESCRIPTION OF THE DRAWINGS

The invention will be described in further detail on the following diagrams.

They illustrate:

FIG. 1 Example of a filter array as a component of a structural plate in an invention-based arrangement,

FIG. 2 A further example of a filter array,

FIG. 3 An image composition structure usable in connection with the filter array shown in FIG. 2,

FIG. 4 and FIG. 5 Example for the respective visible view mixtures for each eye, as well as

FIG. 6 An illustration for the application of a compressed image composition based on the invention.

### DETAILED DESCRIPTION OF THE DRAWINGS

In an arrangement example, the invention-based configuration for spatially perceptible representation includes:
an image rendering device with multiple individual picture elements αᵢⱼ in a matrix with j lines and i columns, on which the αᵢⱼ picture elements are the displayable partial information from several Aₖ views (k=1 . . . n) of the scene/subject,
one structural plate in the viewing direction in front or behind the image rendering device, that forces the required propagation direction for the light radiated from the αᵢⱼ picture elements, where the structural plate shows multiple optical elements arranged accordingly for this purpose,
the propagation directions within the viewing area in which the viewers are, cross with the multiple intersections which correspond to individual viewing positions, so that from each viewing position a viewer optically perceives with one eye the partial information of a first selection and with the other eye the partial information of a second selection from the Aₖ views (k=1 . . . n).

The structural plate includes several transparent filter elements arranged in p columns and q lines as light-transmitting optical elements. Thereby, the transparent filter elements are respectively located on the structural plate at least partially between essentially opaque filter elements.

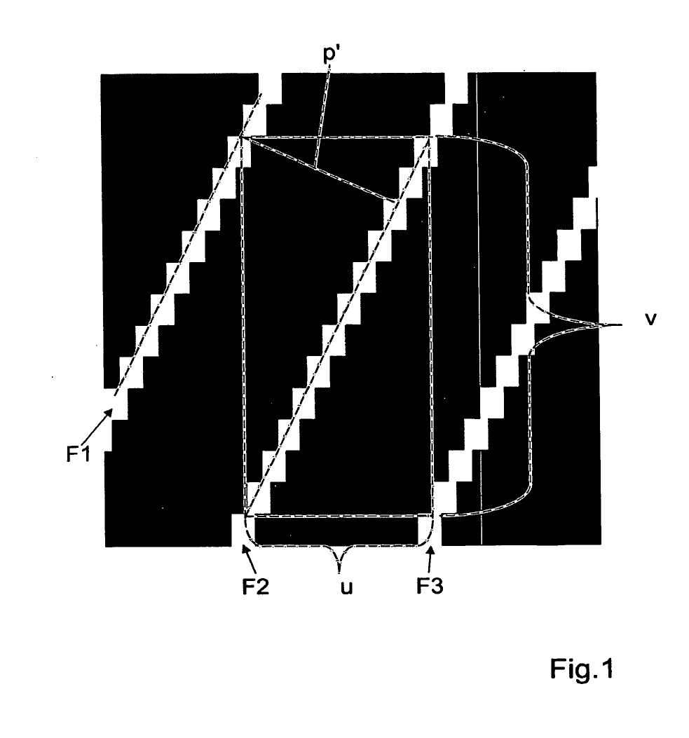

In this preferred arrangement, the transparent filter elements for the entire visible spectrum are arranged in a rectangular array, preferably staggered between each other, where every two transparent filters partially overlap themselves respectively in adjacent lines and columns. Other forms than rectangular shapes are also feasible for the transparent filters. An example for the arrangement of the filter elements is shown in FIG. 1.

Such a structural plate can easily be made from exposed photographic film, which incorporates the transparent and the opaque filter elements and which is laminated on a glass plate. Further arrangements are possible.

In FIG. 1, a series of further transparent filters (F1, F2, F3) are intended to be used as optical elements, as it is schematically indicated (the diagram is not at full-scale). Preferably, the structure of the optical elements is developed periodically.

The distance of the two nearest contiguous elements can be easily calculated according to FIG. 1 as follows:

Being ‘u’ the width and ‘v’ the height of the smallest structural sections which form the entire structure of the optical structural plate, with constant and complete repetition but without partial misalignment (like for example, misalignment around a third without changes)—in this case, the filter array. It furthermore applies that v=3*EZy*a and u=EZx*a. ‘a’ represents here a variable fundamental unit, while the factor 3 is introduced, in order to consider the RGB color sub pixel structure in cooperation with the dimensions of the filter elements.

The ‘a’ parameter depends proportionally on the size of the αᵢⱼ picture elements, i.e. if the size of the aᵢⱼ picture elements is reduced, then ‘a’ also becomes smaller.

Then equation (1) applies:

$${p}^{′} = 3 \cdot {EZ}_{x} \cdot {EZ}_{y} \cdot \frac{a}{\sqrt{{EZ}_{x}^{2} + {3}^{2} \cdot {EZ}_{y}^{2}}}$$

For the special case that the series of transparent and opaque filters are not strictly arranged in series, but rather show variable distances between the transparent filter elements, the average distance—this is, the arithmetic mean of all the different individual distances p′—is relevant.

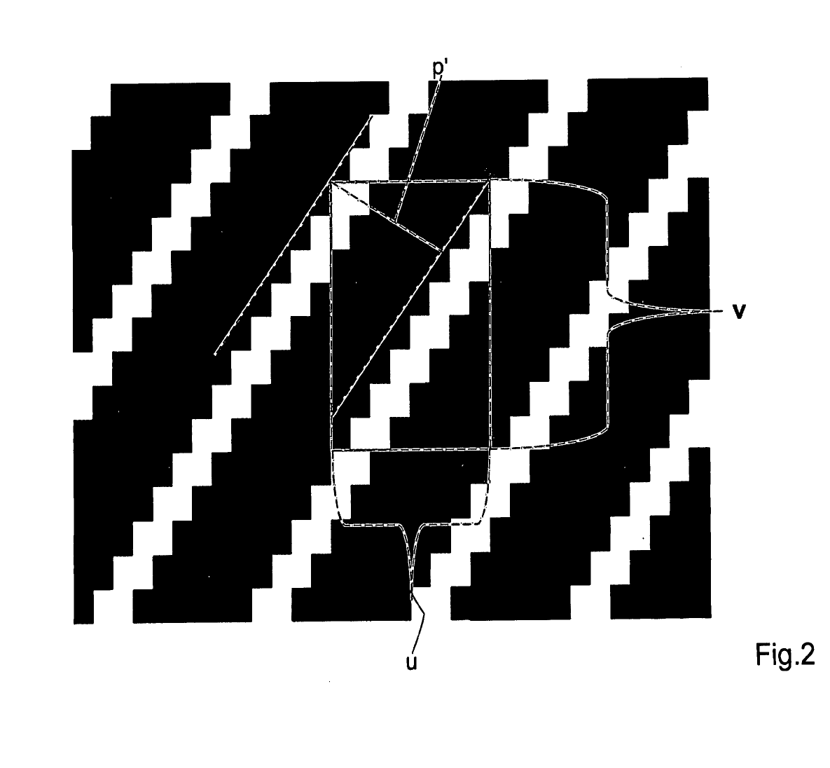

In particular, the geometrical distance of the main propagation directions of two adjacent series can be calculated as the distance of adjacent series of transparent filter elements. In FIG. 1 and in FIG. 2 such main propagation directions are represented for the series.

The implementation of the configuration example given in the conference is described in more detail next.

For this example, a 17″ TFT-LCD ViewSonic VX700 monitor was used as an image rendering device with multiple individual αᵢⱼ picture elements in a matrix with J lines and i columns, where the αᵢⱼ picture elements correspond to the RGB color sub pixels. An electronic control, which can consist for example of a commercial PC, ensures that the partial information from several Aₖ views (k=1 . . . n) of the scene/subject is displayed on the αᵢⱼ image elements.

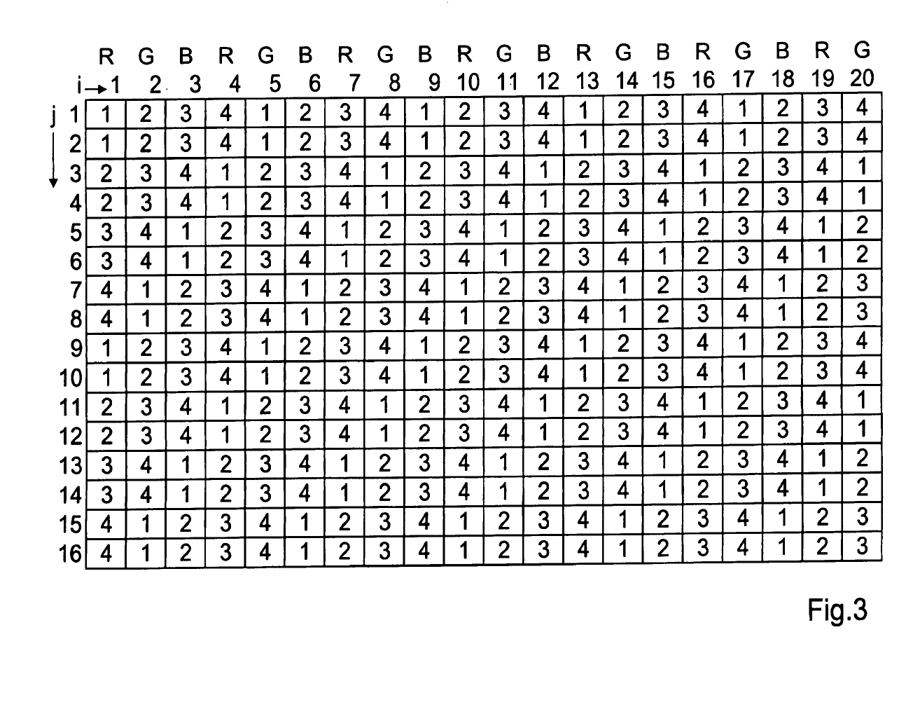

For example, the illustration in FIG. 3 can be selected as an image rendering structure for the representation of the partial information from several Aₖ views (k=1 . . . n) on the αᵢⱼ picture. The numbers in the small boxes correspond to the k numbers of the Aₖ views, from which the picture information comes from, which are displayed in the corresponding position in the matrix of the αᵢⱼ picture elements. The highest line “RGBRGB . . . ” denotes that it handles the αᵢⱼ picture elements as the RGB color sub pixels of the image rendering device. For example, the ‘a’ quantity is directly proportional to the width of the αᵢⱼ picture elements, this is, the RGB color sub pixels.

With the mentioned 17″ LCD monitor, the full color pixel distance is of 0.264 mm. Thus each RGB sub pixel is 0.264 mm high and 0.088 mm wide. An example of the filter array for the configuration shown in the conference is illustrated in FIG. 2 (not at full-scale). In this example, v=3*EZy*a and u=EZx*a with EZy=8, EZx=4 as well as a=0.088 mm and f=0.087881022 mm, with f=65/65.088=0.998647 (correction factor for the transparent filter dimensions).

From the above mentioned equation (1), result values of p′=3.946 and of a=0.3467 mm for the case of the parameters mentioned for the filter illustrated in FIG. 2.

As G is 4 times the diagonal length of the matrix, i.e. in this case of the 17″ LCD, it results that G=1727 mm. Therefore, the above imported variable p=G*sin (0.017°)=0.5125 mm.

Therefore, for this example the invention-based criterion applies that the average geometrical distance p′ for two adjacent series of light-transmitting optical elements on the structural plate fulfills in each case the p′≦p condition, for which applies that p=G*sin (0.017), where G is the quadruple of the diagonal length of the αᵢⱼ picture elements matrix.

In case that the ‘a’ value were smaller than the selected one, e.g. a=0.08 mm, then p′=0.316 mm. In this special arrangement, the average geometrical distance p′ for two adjacent series of light-transmitting optical elements on an even structural plate fulfills in each case the p′≦p′″≦p condition, for which applies that p″=H*sin (0.017), where H is two-and-one-half times the diagonal length of the αᵢⱼ picture elements matrix. Thereby a normally sighted viewer with a visual acuity of S=1 could not visually resolve the adjacent series of light-transmitting optical elements from a viewing distance of 2.5 times the diagonal length of the αᵢⱼ picture elements matrix. Further improvements, like in particular the ongoing technical trend of reducing the width and height of the image rendering elements (e.g. with future image rendering devices), also serve indirectly for reducing the ‘a’ parameter; thus the aforementioned non resolvability can be achieved from even shorter viewing distances than distance H. This is included in the context of the invention.

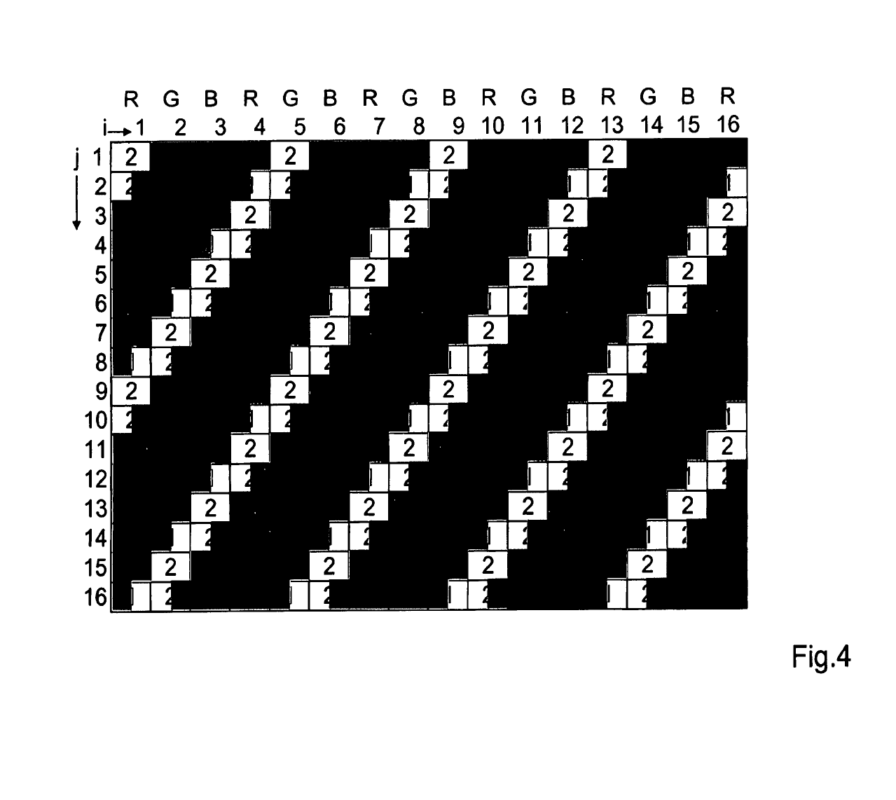

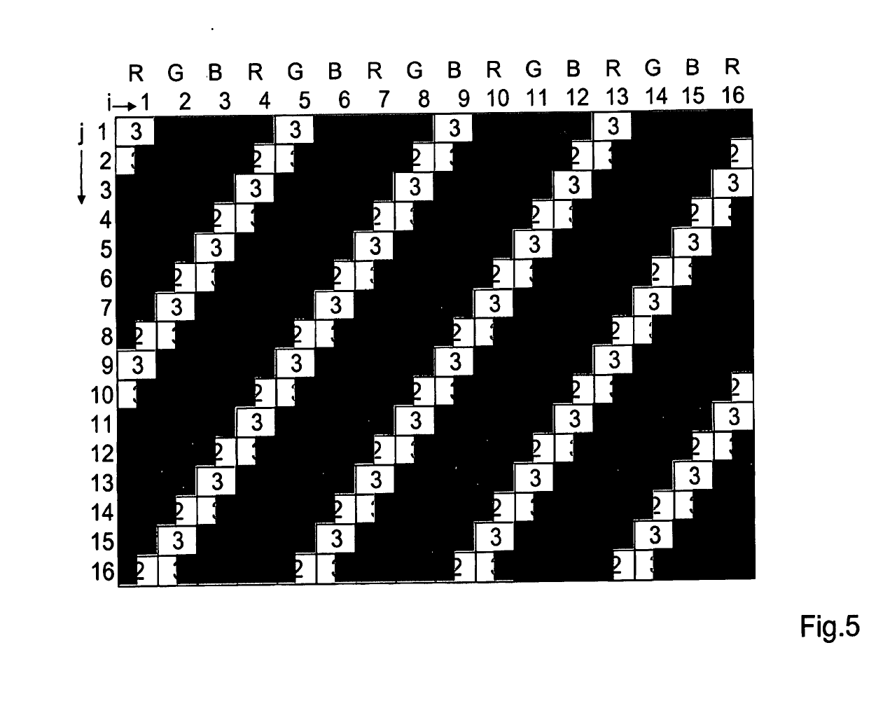

In the arrangement example, the partial information corresponds to the first and second selections from the Aₖ, views (k=1 . . . n), which a viewer perceives optically in both eyes the respective partial and precise information of one or several Aₖ views (k=1 . . . n), whereby the viewer optically perceives with each eye in each case exclusively the mentioned partial information for the first and second selections. The applicant describes the above mentioned facts in further detail in DE 100 03 326 C2, as well as on FIG. 4 and FIG. 5. The vision of excluding partial view information per eye for achieving the spatial impression is described in the already mentioned PCT/EP2004/004464. An improved 3D impression is obtained by the non resolvability feature of the optical elements.

The distance ‘d’ between the filter array and the structural plate and the surface of the image rendering device must preferably measure a few millimeters, for example, d=1.6 millimeter.

A further advantageous configuration of the invention's procedures provides that the viewing area must include at least those levels which:
are in a forwards viewing direction,
are parallel to the αᵢⱼ image elements matrix, and
are located within a distance of 2.5 or 4 times the diagonal length of the matrix.

The known arrangements for spatially perceptible representations, which are based on lenticular or filter arrays, usually result in a preferential viewing distance for the viewer, from which the displayed 3D image is particularly well perceptible.

The preferred viewing distance ‘w’ is determined with the equation in devices with filter arrays, for example the above mentioned 17″ LCD monitor, on which w=65 mm d/0.088 mm, where ‘d’ corresponds to the distance between the filter array and the image rendering surface of the LCD monitor. For the case of d=1.6 mm, it results that w=1181 mm. The actual viewing area stretches before and behind this distance in the viewing direction, so that basically the levels are parallel to the picture elements matrix at a distance of 2.5 or 4 times the diagonal length of the matrix enclosed in the viewing area. In special applications, the preferable viewing distance ‘w’ can also correspond for instance to the value of 2.5 or 4 times the diagonal length of the matrix.

This way, the preferred viewing distance which becomes inseparably related to the corresponding (minimal) required distance for not visually dissolving the optical elements of the 30 optical effect (in this case, the optical elements on the structural plate).

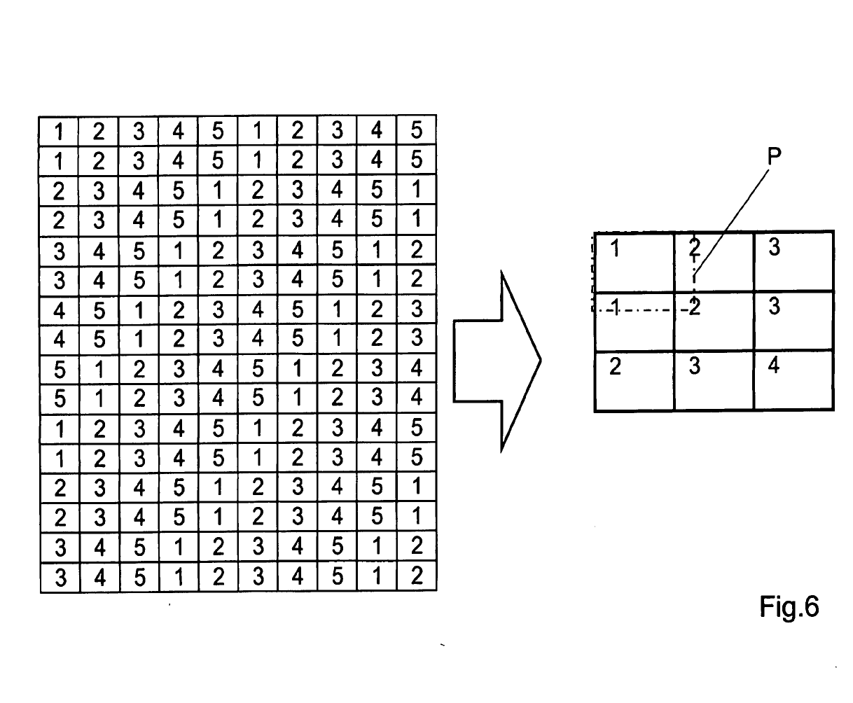

FIG. 6 shows a diagram of the application for a compressed image composition based on the invention. When such a compression or stretch approach is used, at least one αᵢⱼ picture element can be displayed out of the partial information from at least two different Aₖ views (k=1 . . . n) of the scene/subject mixed partial information. The applicant explains the impact of such approach in WO 03/024122.

An image composing sample for n=5 views can be seen at the left of FIG. 6. However, the filter shown in FIG. 2 requires preferably an image composition, which displays a horizontal series of 4 αᵢⱼ picture elements and a vertical series of 8 αᵢⱼ picture elements, while the displayed 5-view structure has one series of 5 or 10 αᵢⱼ picture elements. If the 5-view combination is to be used, it must be “bundled” with a width of 4 views and a height of 8 views.

This makes the picture compression possible, with which the partial information is occasionally assigned to picture elements and simultaneously to several views as a mixture. Referring to the theory from WO 03/024122, the density factors for the horizontal and vertical direction can be considered as dfx=dfy=5/4=1.25. In other words: A real picture element of the 17″ LCD monitor usually displays a mixed image from the partial information of 1.25 partial informations. This is schematically illustrated in FIG. 6: the right side section enlargement shows several a picture elements from the image composition structure. A “real” picture element P would therefore display simultaneously partial information in accordance with the image combination structure of views 1 and 2 as a mixture; for example, a mixture of the partial information of views 2, 3 and 4 would be also possible.

Thus with the mentioned compression of the image composition, the desired series of image composition for the filter array is achieved on the LCD monitor or on the image rendering device. The preceding example serves only for explanation purposes. In practice other density factors, for example those lying between 1.1 and 1.4, will have a greater importance.

It is usually determined that it is beneficial to use the aforementioned compression or stretch approach, when one of the structural plates based on the invention, in particular filter arrays, are fitted over the image rendering device (LCD). For this, a given image composing structure is simply adapted to its series, this means suitably compressed or stretched, so that it is adequate for displaying the corresponding 30 optical effect (e.g. filter array).

In those applications of the invention with filter arrays, the use of transparent filter elements can also be foreseen, which can respectively display different outlines and/or inclinations.

Furthermore, the invention-based applications can also be used as complete or partial exchangeable surface overlays for displaying in 2D or 3D modes. Examples for such means are described in WO 2004/057878 and other writings.

The invention offers on the one hand the advantage that the arrangements and procedures of the initially mentioned kind of structure for the 3D optics for the normally sighted naked eye are designed to be indissoluble as far as possible. On the other hand, the visible resolving of the 3D image is increased at the same time. Thus the quality of the spatially perceptible representation will improve and the undesired picture effects are minimized.

1. Procedure for the spatially perceptible representation of a scene/subject, in which several individual picture elements (αᵢⱼ) are made visible simultaneously in a matrix with j lines and i columns, where
the αᵢⱼ picture elements display partial information from several views (Aₖ where k=1 . . . n) of a scene/subject,
a structural plate allows to force the propagation directions of the light radiated from the αᵢⱼ picture elements, and for this purpose the structural plate shows several optical elements arranged in series,
so that the propagation directions within a viewing area, in which the viewer (s) is (are), cross with several intersections, which correspond in each case to a viewing position,
whereby from each view position a viewer optically perceives with one eye the partial information of a first selection and with the other eye optically perceives the partial information of a second selection from the Aₖ views (k=1 . . . n), whereby according to the invention,
the average geometrical distance p between two adjacent series of light-transmitting optical elements on the structural plate, fulfills the p′≦p condition, on which p=G*sin(0.017), where G is the quadruple of the diagonal length of the αᵢⱼ picture elements matrix.

2. Procedure following requirement 1, characterized by the fact that the average geometrical distance p′ between two adjacent series of light-transmitting optical elements on the structural plate, fulfills the p′≦p′″≦p condition, on which p′″=H*sin (0.017°), where H is two-and-one-half times the diagonal length of the αᵢⱼ picture elements matrix.

3. Procedure following requirement 1, further characterized by a structural plate with several cylindrical lenses arranged in a matrix with p columns and q lines which are intended to serve as light-transmitting optical elements.

4. Procedure following requirement 1, further characterized by a structural plate with a several transparent filter elements arranged in a matrix with p columns and q lines respectively, which are intended to serve as light-transmitting optical elements, and these transparent filter elements on the structural plate are respectively located at least partially between essentially opaque filter elements.

5. Procedure following requirement 1, further characterized by the fact that the partial information of the first and second selections from the Aₖ view's (k=1 . . . n), is optically perceived by a viewer with one eye and with the other; this exact and precise partial information corresponds to one or several Aₖ views (k=1 . . . n), whereby the viewer preferably perceives with each eye the corresponding inclusive or exclusive partial information implied in the first and second selections.

6. Procedure following requirement 5, characterized by the fact that the viewing area in which the viewers are located, includes at least that level or those levels, which
are oriented in a forwards viewing direction, and
are parallel to the αᵢⱼ picture elements matrix, and
are respectively located at a distance of 2.5 or 4 times the diagonal length of the matrix.

7. Procedure following requirement 1, further characterized by the fact that at least one αᵢⱼ picture element displays partial information from at least two different Aₖ views (k=1 . . . n) of the scene/subject mixed partial information.

8. Arrangement for the spatially perceptible representation of a scene/subject, including:
an image rendering device with several individual αᵢⱼ picture elements in a matrix with j lines and i columns, on which the αᵢⱼ picture elements reproduce partial information from several Aₖ views (k=1 . . . n) of the scene/subject.
at least one structural plate arranged in the viewing direction before or behind the image rendering mechanism under the requirements of the propagation directions for the light radiated from the αᵢⱼ picture elements, whereby the structural plate shows several optical elements arranged in series for this purpose,
where the propagation directions within the viewing area in which the viewers are, cross with several intersections, which correspond in each case to a viewing position, so that a viewer optically perceives, for each viewing position, with one eye the partial information of a first selection, and with the other eye the partial information of a second selection from the Aₖ views (k=1 . . . n), whereby according to the invention,
the average geometrical distance p between two adjacent series of light-transmitting optical elements on the structural plate, fulfills the p′≦p condition, on which p=G*sin (0.017) where G is four times the diagonal length of the αᵢⱼ picture elements matrix.

9. Arrangement following requirement 8, characterized by the fact that the average geometrical distance p′ between two adjacent series of light-transmitting optical elements on the structural plate, fulfills the p′≦p′″≦p condition, on which p′″=H*sin (0.017), where H is two-and-one-half times the diagonal length of the αᵢⱼ picture elements matrix.

10. Arrangement following requirement 8, further characterized by a structural plate with several cylindrical lenses arranged in a matrix with p columns and q lines, intended to serve as light-transmitting optical elements.

11. Arrangement following requirement 8, further characterized by a structural plate with several transparent filter elements arranged in p columns and q lines, intended to serve as light-transmitting optical elements, where the transparent filter elements on the structural plate are in each case located at least partially between basically opaque filter elements.

12. Arrangement following requirement 8, further characterized by the fact that the partial information of the first and the second selection from the Aₖ views (k=1 . . . n), which a viewer can optically perceive with one eye with the other eye, correspond respectively to the exact and precise partial information of one or several Aₖ views (k=1 . . . n), whereby the viewer preferably perceives with each eye exclusively the mentioned partial information for the first and second selections.

13. Arrangement following requirement 12, characterized by the fact that the viewing area in which the viewers are placed includes at least that level or those levels, which
are oriented in a forwards viewing direction, and
are parallel to the αᵢⱼ picture elements matrix, and
are respectively located at a distance of 2.5 or 4 times the diagonal length of the matrix.

14. Arrangement following requirement 8, further characterized by the fact that at least the reproduced partial information on one aᵢⱼ picture element is mixed partial information from at least two different Aₖ views (k=1 . . . n) of the scene/subject.
